(19) United States
(12) Patent Application Publication
(10) Pub. No.: US 2005/0190954 A1
(43) Pub. Date: Sep. 1, 2005

(54) Pressure sensitive sensor

(76) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/069,606

(22) Filed: Mar. 1, 2005

Related U.S. Application Data
(60) Provisional application No. 60/549,073, filed on Mar. 1, 2004.

(51) Int. Cl. G06K 9/00

(52) U.S. Cl. 382/124

(57) ABSTRACT

A apparatus for obtaining a print image comprising an array of transistors, a gate layer coupled to a gate voltage level, and a compressible dielectric layer, wherein said array of transistors provides an output indicative of said print image by sensing pressure levels associated with said print image.

### RELATED APPLICATION

The present invention claims priority to U.S. Provisional Application No. 60/549,073, filed on Mar. 1, 2004, which is fully incorporated herein by reference.

### FIELD

The present invention relates generally to the field of sensors, and, more specifically, to pressure sensitive fingerprint sensors.

### BACKGROUND

Fingerprints have been widely used for many years as a means for identification or verification of an individual's identity. For many years, experts in the field of fingerprints would manually compare sample fingerprints to determine if two prints matched each other, which allowed for identification or verification of the person that created the fingerprint. In more recent times, fingerprint recognition has been improved by using computer analysis techniques developed to compare a fingerprint with one or more stored sample fingerprints.

Computer analysis of fingerprints has typically required obtaining a fingerprint sample for analysis from a fingerprint sensor. Typically, fingerprint sensors have used one of basic three techniques to capture a fingerprint sample. The three basic techniques are thermal sensing, optical sensing, and capacitive sensing.

Thermal sensing is performed using a sensor that contains an array of temperature measurement pixels. The pixels are sensitive to the difference in temperature between skin (as would be found along a ridge) and air (as would be found along a valley). Because thermal sensors rely on an array of temperature readings, they typically require a series of analog-to-digital conversions at each pixel. This often results in slower than desired processing of the fingerprint image.

Capacitive sensing is typically performed using a sensor that contains an array of pixels that measure capacitive values. The pixels are sensitive to the difference in capacitance between areas contacted by skin (as would be found along a ridge) and areas contacted by air (as would be found along a valley). Similar to thermal sensors, these sensors typically require a series of analog-to-digital conversions at each pixel, which often results in slower than desired processing of the fingerprint image.

Optical sensing is typically performed by illuminating a fingerprint using a light source. A series of lenses or prisms are typically used to project the image on an image sensor, where it is captured using a camera device. These sensors typically require sensitive optics and small camera devices, which typically causes such devices to be bulky and expensive.

Prior to the present invention, a need existed for a sensing technique or sensor that overcomes these shortcomings. The present invention fulfills this need, among others.

### SUMMARY

An apparatus is advantageously provided for obtaining a print image. The apparatus comprises an array of transistors, a gate layer coupled to a gate voltage level, and a compressible dielectric layer, wherein said array of transistors provides an output indicative of said print image by sensing pressure levels associated with said print image.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 illustrates an exemplary finger print sensor prior to the application of a finger in accordance with an exemplary embodiment of the present invention.

FIG. 2 illustrates the exemplary finger print sensor of FIG. 1 during the imaging process in accordance with an exemplary embodiment of the present invention.

FIG. 3 is a graph illustrating the relationship between pressure and voltage for transistors employed in an exemplary embodiment of the present invention.

### DETAILED DESCRIPTION OF CERTAIN PREFERRED EMBODIMENTS

Overview

Various types of systems have attempted to employ fingerprint imaging techniques in recent times. Increased security concerns present in today's world makes fingerprint identification and/or verification a field of great interest. Many applications using devices having limited memory and/or computing power (e.g., smart cards) would benefit greatly by being able to use fingerprint sensing techniques to reduce security concerns. One limiting factor to date has been the size and complexity of sensors required to obtain electronic images of fingerprints. A method of obtaining fingerprint images for processing that requires less computing resources is provided by the exemplary embodiment of the present invention. While the exemplary embodiment is discussed with reference solely to fingerprints, it should be noted-that exemplary embodiment is applicable to all types of prints, including thumbprints, toe prints, palm prints, etc.

Pressure Sensitive Fingerprint Sensor

In the exemplary embodiment of the present invention, a fingerprint image is obtained using a sensor to generate an image that comprises a matrix cells, or smaller images. The number of cells may vary depending upon the level of detail of a print image required by a particular application. For example, a typical fingerprint sensor supports a resolution of 500 dots per inch (DPI). For a typical swipe sensor, this may be a matrix of 8 rows each having 250 columns. In such an example, a cell matrix of 2000 cells would be needed to support the desired resolution, which typically requires 2000 individual transistors in an embodiment where each cell comprises a single transistor.

In an exemplary embodiment, the cells each comprise a single transistor, typically a complementary metal oxide semiconductor (CMOS) transistor. The properties of the CMOS transistors are used to create an image of a fingerprint that is applied to the sensor, as described below.

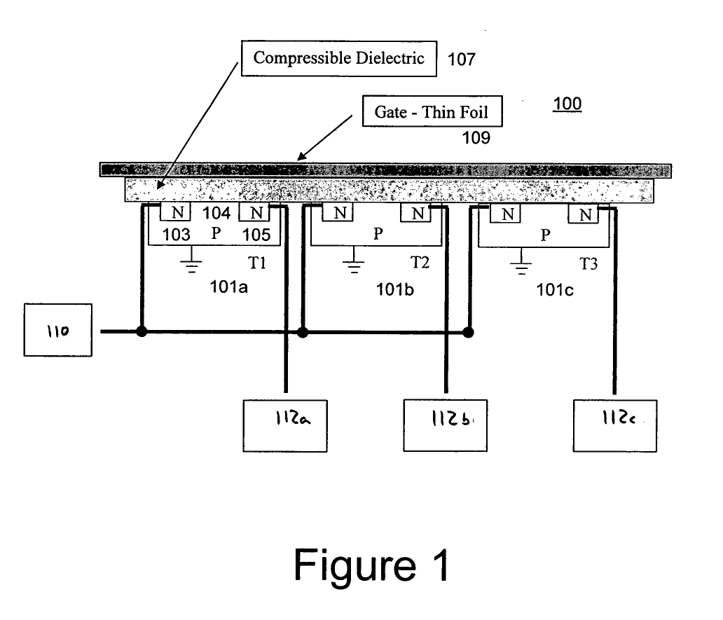

The conduction of a CMOS transistor is typically dependent upon a gate voltage and insulating characteristics of a dielectric layer. Referring to FIG. 1, an exemplary sensor 100 in accordance with the present invention is shown. A series of transistors 101a, 101b, 101c are formed in a semiconductor substrate (e.g., silicon). While in the embodiment illustrated, the transistors 101a, 101b, 101c are negative-positive-negative (NPN) type transistors, other types of transistors may also be used and such types would be readily apparent, to one of skill in the art. Each transistor is similar in natures, and thus only one transistor 101a shall be described in detail. The transistor 101a comprises a first negative (N) contact 103 and a second N contact 105. The N contacts 103, 105 are separated by a positive (P) region 104.

A compressible dielectric layer 107 is coupled to the transistor 101a. Compressible dielectric layers have recently been developed that use nanopores inside the dielectric material to alter the electrical characteristics of the device. Such materials combine two types of materials to form a dielectric material that is compressible, resembling a sponge. The compressible dielectric material comprises a matrix material having a high thermal stability and a second material, typically a plastic, that begins to break down at a lower temperature than the matrix material. The material is heated to a threshold temperature sufficient to cause breakdown of the second material, causing a gas of monomers to form from the breakdown. The gas escapes from the dielectric and is replaced by small air pockets, which results in the creation of a sponge-like compressible dielectric material. The formation of such materials is known to those of skill in the art.

A gate layer 109 is located on one side of the dielectric layer 107, opposite from the transistor 101a. The gate layer typically comprises a conductive material, such as a conductive thin foil. The transistor 101a operates in a typical manner, that is by turning to the “on” state, or allowing conduction between the first N contact 103 and the second N contact 105 when the gate layer 109 reaches a certain threshold voltage sufficient to allow such conduction.

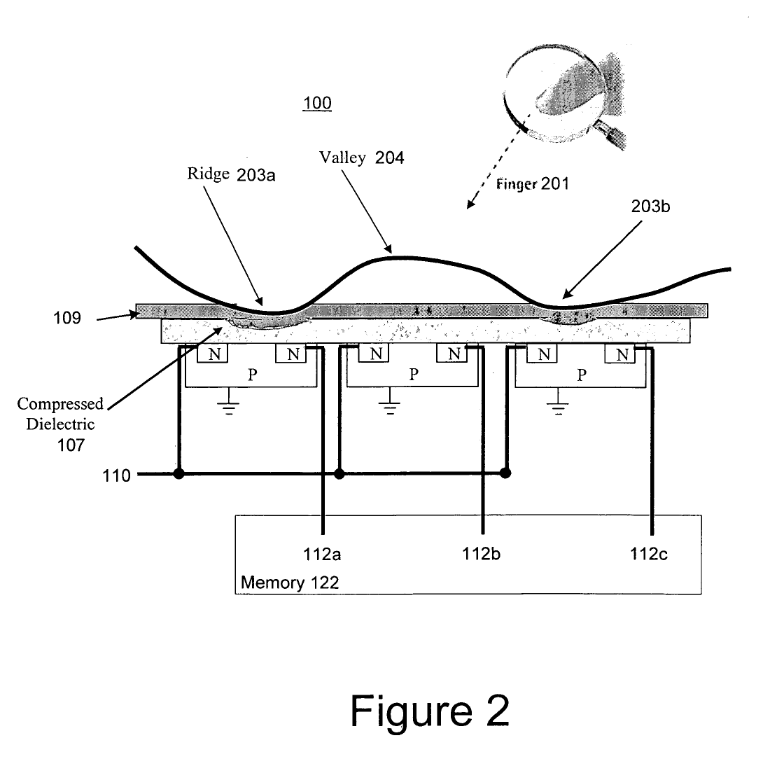

Referring to FIG. 2, the operation of a sensor device in accordance with an exemplary embodiment of the present invention is shown. A user places his or her finger 201 on the sensor 100. A fingerprint comprises a series of ridges and valleys formed in the tip of the finger 201. Referring to FIG. 2, two ridges 203a, 203b are shown with a valley 204 that resides between the ridges 203a, 203b. The ridges 203a, 203b provide pressure on the gate layer 109, which in turn provides pressure on the dielectric layer 107. As the dielectric layer 107 is made of a compressible dielectric material, the pressure from the ridges 203a 203b on the foil comprising the gate layer 109 causes the dielectric layer 107 to be compressed in the areas beneath the ridge to a greater extent than in the areas underneath a valley, thus distinguishing these features. When the dielectric layer 107 compresses, the dynamics of the transistor located in the area of the compression changes.

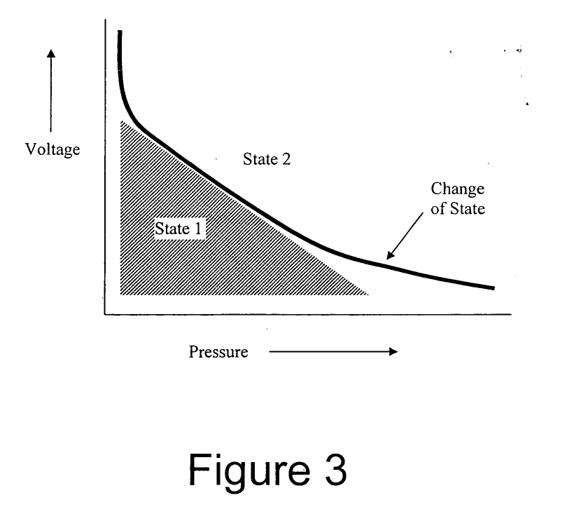

The relationship between pressure on the dielectric layer and the voltage level required to change the state of a transistor (i.e., from “off” to “on”) is illustrated in FIG. 3. Referring to FIG. 3, a graph is shown illustrating the relationship between pressure (shown on the x-axis) and voltage (shown on the y-axis) as relating to the change in the state of a transistor. As the pressure on the compressible dielectric layer 107 increases, the gate voltage level required to activate the transistor is lowered.

The various pressure levels caused by the fingerprint features (i.e., ridges and valleys) creates a pressure gradient profile that extends across the matrix of transistors in the sensor along the line of a fingerprint ridge. The pressure will be the greatest at points along the center of a ridge, causing the dielectric layer 107 to compress the greatest amount at points corresponding the center of a ridge. As a result, transistors located under a ridge will tend to change state at a lower voltage than transistors located under a valley. For a constant gate voltage, this results in transistors changing state when sufficient pressure is applied (e.g., as when under a ridge), but not changing state when less than sufficient pressure is applied (e.g., as when under a valley).

The various pressures applied to the dielectric layer 107 over the array of transistors in the sensor allows for a matrix of measured voltages to be stored in a memory 122 representing which transistors have changed states upon application of the finger 101. This information indicates where the ridges and valleys occur within an applied print. The construction of the sensor as shown in FIGS. 1 and 2 is simplified over prior art sensors that attempt to use a matrix of transistors (e.g., capacitive sensors). This is the because all of the inputs or source gates of the transistors (e.g., first N contact 103) can be coupled to a single voltage input source 110. Each transistor has an output (e.g., drain gate), and it is the outputs 112a, 112b, 112c, that are individually connected to memory locations in the memory 122.

The sensitivity of a sensor in accordance with an exemplary embodiment of the present invention, or resolution of an image obtained from a sensor, can be increased in two ways. One technique is to take multiple memory readings while the voltage level applied to the gate layer 109 is varied. The gate layer voltage can be varied in fine increments, causing the various transistors to change states at varying voltage levels. A more detailed profile of the surface (e.g., the fingerprint) can be obtained from the-obtaining when each transistor changes state. For example, transistors in areas of higher pressure (e.g., along the center of a ridge) will change state at lower voltages than those of lesser pressure (e.g., along the edge of a ridge) or no pressure (e.g., along a valley). By recording the point at which each transistor changes state across a range of finely incremented voltage levels, a detailed print image is obtained.

A second technique to improve the resolution of an image obtained from a sensor in accordance with an exemplary embodiment of the present invention is to use dielectric layers of multiple thicknesses in conjunction with small transistors in close proximity to each other. For example, the transistors associated with the thicker dielectric layer will require higher levels of pressure to change states than those associated with a thinner dielectric layer for a constant gate voltage. Thus, for example, a series of transistors having varying thickness dielectric layers may all change states when located beneath the center of a ridge on the applied fingerprint, while only some of the transistors may change states when located beneath the edge of a ridge on the applied fingerprint, and none may change states when located beneath a valley on the applied fingerprint. Thus, by dividing the sensor into cells having a series of very small transistors having finely incremented dielectric layer thicknesses in place of a single transistor, the resolution of the sensor can be increased.

In addition to the sensor elements shown in FIGS. 1 and 2, a protective layer is typically located on top of the gate layer 109. For simplicity, the protective layer is not shown in the Figures. The protective layer is typically a flexible insulating layer, such as an insulating coating or film. Various types of flexible insulating layers, such as but not limited to polymer film not necessarily transparent) may be used, provided that the insulating layer does not diminish the sensitivity of the surface to pressure. In addition to providing mechanical protection, this layer provides for protection from static discharge, which has caused problems with capacitive type sensors.

The exemplary embodiment of the present invention allows for a fingerprint image to be obtained using a pressure sensitive sensor. Other embodiments allow for the techniques described herein to be used to obtain surface profiles of objects other than fingerprints, such as mechanical objects with variable surface features. Additionally, a variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A apparatus for obtaining a print image comprising:
an array of transistors;
a gate layer coupled to a gate voltage level; and
a compressible dielectric layer between said transistors and said gate layer;
wherein said array of transistors provides an output indicative of said print image by sensing pressure levels associated with said print image.

2. The apparatus as set forth in claim 1, further comprising:
a memory, wherein each transistor in said array of transistors has a transistor output, and said transistor output is stored in said memory.

3. The apparatus as set forth in claim 2, wherein said gate voltage level is varied, and said memory stores a matrix of measured voltage at which each transistor output changes state.

4. The apparatus as set forth in claim 1, wherein each transistor in said array of transistors is coupled to a common input.

5. The apparatus as set forth in claim 1, wherein said array of transistors comprises an array of negative-positive-negative (NPN) devices.

6. The apparatus as set forth in claim 1, wherein said output indicates the location of ridges and valleys within said print image.

7. The apparatus as set forth in claim 1, wherein said array of transistors is grouped into cells, each cell comprising a plurality of transistors, and said compressible dielectric layer has multiple thicknesses, wherein a transistor in a particular cell is associated with an area of said dielectric layer having a particular thickness.

8. A method for obtaining a fingerprint image comprising:
providing an array of transistors beneath a compressible dielectric layer in a fingerprint sensor;
applying a fingerprint to the sensor;
creating an image of said fingerprint, wherein said image corresponds to outputs from each of the transistors in said array of transistors, said outputs reflective of a pressure level applied to said compressible dielectric layer in a location corresponding to each transistor; and
storing said image in a memory.

9. The method as set forth in claim 8, wherein said array of transistors has a gate layer coupled to a voltage level, and wherein said method further comprises:
varying said gate voltage level; and
storing in said memory the voltage at which each transistor output changes state.

10. The method set forth in claim 8, wherein each transistor in said array of transistors is coupled to a common input.

11. The method as set forth in claim 8, wherein said array of transistors comprises an array of NPN devices.

12. The method as set forth in claim 8, wherein said image is representative of the location of ridges and valleys within said print image.

13. The method as set forth in claim 8, wherein said array of transistors is grouped into cells, each cell comprising a plurality of transistors, and said compressible dielectric layer has multiple thicknesses, wherein a transistor in a particular cell is associated with an area of said dielectric layer having a particular thickness.
